(19) United States
(12) Patent Application Publication
(10) Pub. No.: US 2014/0177575 A1
(43) Pub. Date: Jun. 26, 2014

(54) METHOD FOR ESTABLISHING AN APPLICATION SESSION, DEVICE AND CORRESPONDING NOTIFICATION

(71) Applicant: SAGEMCOM ENERGY & TELECOM SAS, Rueil-Malmaison (FR)

(72) Inventors: Djelal RAOUF, Rueil-Malmaison (FR); Michael Boutboul, Rueil-Malmaison (FR)

(73) Assignee: SAGEMCOM ENERGY & TELECOM SAS, Rueil-Malmaison (FR)

(21) Appl. No.: 14/193,732

(22) Filed: Feb. 28, 2014

Related U.S. Application Data
(63) Continuation of application No. 13/502,758, filed on Apr. 19, 2012, now abandoned.

(30) Foreign Application Priority Data
Oct. 27, 2009 (FR) 09/57544

(51) Int. Cl. H04W 76/02

(52) U.S. Cl. CPC H04W 76/023
USPC 370/329

(57) ABSTRACT

In the field of mobile telephony and more particularly the field of so-cal led machine-to-machine communication modules, the invention aims to define a notification format for establishing an application session integrating the operator connection parameters. In this case, in the case of GPRS, this entails the name of the gateway and connection identifiers.

### BACKGROUND OF THE INVENTION

This application is a continuation of application Ser. No. 13/502,758, filed Apr. 19, 2012, which is the U.S. national phase of International Application No. PCT/EP2010/066130, filed 26 Oct. 2010, which designated the U.S. and claims priority to France Application No. 09/57544, filed 27 Oct. 2009, the entire contents of each of which are hereby incorporated by reference.

The present invention concerns the field of mobile telephony and more particularly the field of so-called machine-to-machine communication modules. However, it can apply to any wireless telephone communication device,

Originally, wireless telephone communication devices consisted of simple handsets for transmitting voice by means of a cellular radio network. Very quickly, the simple transport of voice proved to be insufficient and the terminals were provided with data communication means according to packet communication protocols such as the IP protocol (Internet Protocol defined by RFC 791). These developments have given rise to various generations of communication standards such as GPRS (General Packet Radio Service), EDGE (Enhanced Data Rates for GPRS Evolution), UMTS (Universal Mobile Telecommunications System), and HSUPA (High Speed Uplink Packet Access).

From a highly schematic point of view, the scheme for connection of a mobile telephony device to the data communication network can be described according to FIG. 1. According to a first step 1.1, the device connects to an APN (Access Point Name), the name of the interconnection gateway between the mobile packet network (GPRS or UMTS) and the external IP networks. It must therefore for this purpose have this name or APN of the gateway. Next, it identifies itself to this gateway by means of a connection name (login) and a password during an authentication step 1.2. It then receives, during a step 1.3, a context generally referred to as the PDP context, a set of parameters for establishing the IP sessions. This session is then established during step 1.4.

This session establishment process is designed to be initiated by the mobile terminal. There does not exist any simple means for a server connected to the IP network to initiate a data session for communicating according to the data communication protocol with a distant device. In addition, the network quickly disconnects the session of a terminal that is no longer sending any data.

To overcome this problem and to enable a server to communicate with a mobile telephony device, several solutions have been described. A first solution makes it possible to keep an already established connection live by means of a so-called keep-alive system consisting of the periodic sending of data for the sole purpose of preventing disconnections. It is also possible to implement a rendezvous mechanism.

According to this mechanism, the terminal periodically connects to a server to enable the latter to transmit any data to it. According to another mechanism, the server sends a voice call from a well known number to the terminal. The latter receives the call, recognises the number, does not pickup, but establishes a session in response to this call. Finally, a last solution, no doubt the most simple to implement, consists of sending an SMS (Short Message Service) to the device to request it to establish a connection or session.

A document standardises this last solution according to the OMA alliance (Open Mobile Alliance); this is the document “OMA-TS-DM_Notification-V1_{—}2_{—}1-20080617-A” entitled “OMA Device Management Notification Initiated Session”.

According to this document, transmitting a notification in the form of an SMS to the terminal is described. On reception of this SMS, the terminal initiates a connection on the server at the origin of the notification. This connection will, in our case, use the GPRS connection established by means of its stored connection parameters such as the name of the gateway and the associated connection identifiers. Unfortunately, in the case of a machine-to-machine connection, this information is not generally stored by the terminal. This is because these terminals are typically configured before the choice of the operator is made. The choice of this operator may be called into question during the operation.

Moreover, it could be useful to allow a connection to a given service using an operator chosen for the service instead of the default operator configured in the apparatus.

### BRIEF SUMMARY OF THE INVENTION

The invention aims to solve the above problems by defining a notification format for establishing an application session integrating the operator connection parameters. In this case, in the case of GPRS, it is the name of the gateway and the connection identifiers.

The invention concerns a method of establishing an application session by an information processing device called client, having means for communicating with a data communication network through a mobile telephony network, characterised in that it comprises a step of receiving a notification according to a first asynchronous communication mode; a step of extracting said notification, firstly the information for establishing an application session and secondly the connection information relating to the operator managing an interconnection gateway between the mobile telephony network and the data communication network; a step of initiating a synchronous connection to said gateway using connection information relating to the operator extracted and a step of initiating an application session using information relating to the application session extracted.

The invention also concerns an information processing device comprising means for communicating with a data communication network through a mobile telephony network; means for receiving notifications according to a first asynchronous communication mode; means for establishing a connection according to a second synchronous communication mode with an interconnection gateway between the mobile telephony network and the data communication network, said gateway being managed by an operator; means for establishing with a server an application session through the communication network and means for extracting said notification, firstly connection information relating to the operator used to enable the establishment of a connection to the data communication network, and secondly the information relating to the establishment of an application session.

The invention also concerns a notification for establishing an application session by an information processing device called client, having means for communicating with a data communication network through a mobile telephony network that comprises the information for establishing an application session and the connection information relating to the operator managing an interconnection gateway between the mobile telephony network and the data communication network,

According to a particular embodiment of the invention, the notification takes the form of a short message.

According to a particular embodiment of the invention, said connection information relating to the operator comprises the name of the gateway, a connection identifier and a password.

### BRIEF DESCRIPTION OF THE DRAWINGS

The features of the invention mentioned above, as well as others, will emerge more clearly from a reading of the following description of an example embodiment, said description being given in relation to the accompanying drawings, among which:

FIG. 1 illustrates the method of connecting a mobile telephony network to a data communication network,

FIG. 2 illustrates the structure of a notification in the OMA system,

FIG. 3 illustrates the structure of an SMS according to an example embodiment of the invention,

FIG. 4 illustrates the functioning of an example embodiment of the invention.

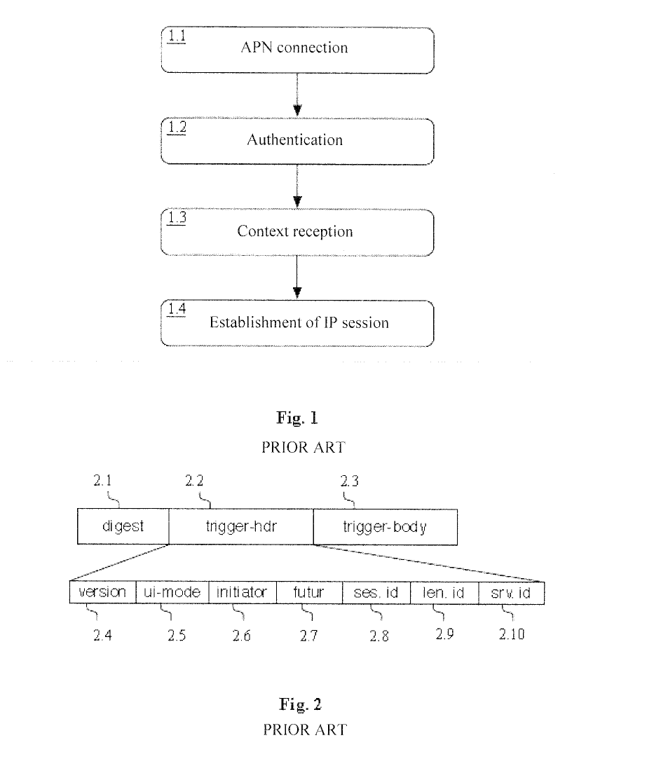

### DETAILED DESCRIPTION OF THE INVENTION

The invention fits in the context where at least two communication modes, or transport layers, allow communication between a client and a server. Client here means an information processing device having means of communicating with a data communication network through a mobile telephony network. The server means an information processing device having means of communication with a communication network and offering a service to clients through this communication network. A first mode is asynchronous and can allow the sending of messages between the client and the server. A second mode is synchronous and makes it possible to establish a connection between the client and the communication network. This connection is established between the client and an interconnection gateway between the mobile telephony network and the data communication network. This connection in synchronous mode enables the client to establish communication sessions with the server at the application level. This is the case where the server is not in a position to establish such a communication session with the client. In the example embodiment, the system is the OMA system. The asynchronous communication mode is the transport layer used for sending asynchronous messages, called WAP-push, typically using the infrastructure for sending short messages SMS. The synchronous communication mode is typically a TCP/IP connection established according to the GPRS standard. The application sessions are typically OMA management sessions. In such a system a server wishing to get in communication at the application level with a client and not being able to himself establish an application session sends a notification in asynchronous mode to the client containing the information enabling this client to establish an application session with the server using synchronous communication mode. However, the invention, although described in the context of an OMA system, can be implemented in any system obeying the same constraints. In particular, it can be applied to any type of session at the application level, as well as to various transport layers.

FIG. 2 illustrates the structure of a notification in the OMA system. This notification consists of a first “digest” field 2.1 that contains an MD5 key for guaranteeing the integrity of the message and authenticating the sender thereof. Next comes a header 2.2 called “trigger-hdr” that contains a set of data enabling the receiver of the notification to establish a management session with the sending server. Such a management session is a session as defined by the OMA standard and is here not a TCP/IP session. This management session is situated at the application layer on top of the TCP/IP protocol and presupposes that the client and server are configured appropriately to enable communication. After the header field comes a data field (payload) 2.3 called “trigger-body” which contains data specific, to the vendor, that is to say to the operator of the system.

The header field is itself broken down into a first version field 2.4 that specifies the version of the OMA specification to which the notification conforms. A field 2.5 follows indicating whether the notification must be indicated to the user or processed by the system, and then an “initiator” field 2.6 that indicates what is the origin of the notification, whether it is a case of a request from the user or server. A space 2.7 is reserved for future use. Next a session identifier 2.8 is found, which must be used by the client when it initiates the session to the server. Thus the link between the initiation of the session by the client and the notification that causes it is established. Next there is found a field 2.9 that gives the length of the identifier of the server sending the notification and the field 2.10 that contains this identifier.

It can be seen that the information available in the structure of the notification as formalised in the OMA system all relate to the establishment of an OMA management session. These sessions are sessions at the application level. No information relates to the underlying transport protocol layers. It is assumed in the system that the client and server are connected and able to communicate.

However, in the case where the client uses a data communication network by mobile such as GPRS, for example, the connection to this network is not necessarily established. When the client has the connection parameters, it can use them for establishing this communication in response to the reception of the notification. It should be noted here that this notification is submitted by WAP push, that is to say in the form of a short message sent asynchronously and not requiring the use of the communication network. In some cases, this information is not stored in the client. This may be the case for example in a machine-to-machine application such as a payment machine where the SIM card used is configured and inserted in the apparatus before the operator contract managing access is negotiated. In some applications, it may also be useful to send a notification for access to a server connected to an operator different from the default operator used by the client,

To enable connection in these cases, it is necessary to communicate the connection information relating to the operator used to enable the establishment of a connection to the data communication network. Typically, this information comprises the name of the access gateway (APN) managed by the operator, a connection identifier (login) and a password. This is for example case with access using a GPRS connection.

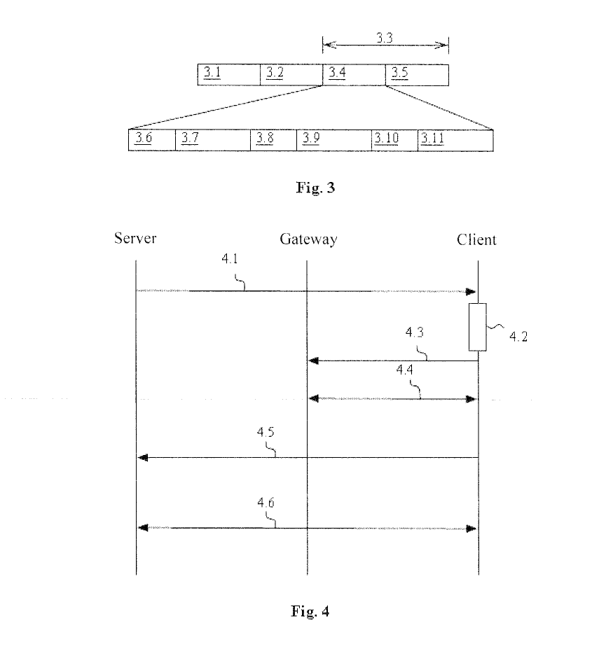

According to the invention, this connection information relating to the operator is transmitted in the short message used for transporting the notification. In this way, the connection information relating to the operator and the information relating to the establishment of an application session is transported in the same message. Advantageously, it is integrated in the notification itself. The example embodiment of the invention inserts a data structure at the start of the body of the notification. This embodiment is illustrated in FIG. 3. The fields 3.1, 3.2 and 3.3 represent the structure of the notification as described previously, respectively the field digest, the field trigger-hdr and the field trigger-body. The field trigger-body 3.3 is reserved for the data specific to the notification; this is the body of the notification. This field is then divided into two parts. A first part 3.4 hosts the data structure containing the connection information relating to the operator according to the invention. The second part 3.5 is available for any supplementary data and is equivalent to the field trigger-body of the prior art.

According to an example embodiment, the data structure 3.4 can be as follows: a first field 3.6 contains the length of the name of the gateway, followed by a field 3.7 containing this name. The field 3.8 contains the length of the connection identifier followed by the field 3.9 containing this identifier. The field 3.10 contains the length of the password followed by the field 3.11 containing this password. It is obvious to a person skilled in the art that this structure is merely one example embodiment and can be adapted. In particular, it is suited to a connection to a GPRS network and should be adapted to any other type of data communication network used according to the connection information then required. This notification is then transported in an SMS in the same way as the notification according to the prior art. It may alternatively be transmitted by any appropriate means other than SMS and be adapted to any transport layer that can be used for transmitting the notifications in asynchronous mode.

Alternatively, this connection information can be inserted directly in the short message or SMS used to transport the notification without being included therein. For example, it is possible to define a new information element in the user data header of the SMS dedicated to transporting this data structure. It is then necessary to define a corresponding information element identifier.

Another alternative consists of inserting this information in the data part of the short message.

FIG. 4 illustrates the functioning of an example embodiment of the invention. It describes a method of establishing an application session by the client. During a first step 4.1, the server wishing to communicate with the client sends it a notification according to the invention in asynchronous mode. During a step 4.2, the client analyses this notification and extracts firstly the information for establishing an application session and secondly the connection information relating to the operator. The whole of the message received is integrated under the name notification. In particular, if the information relating to the operator is inserted in the short message transporting the notification proper rather than in the latter, the whole of the short message is considered to be a notification. Advantageously, it then tests whether it is already connected to the data network via the operator, the connection information of which is communicated to it. If such is not the case, it initiates this synchronous connection by means of the connection information relating to the operator extracted; this is step 4.3. During step 4.4 this connection is established, and the client is now connected to the data network that enables it to communicate with the server. It then uses the information relating to the application session that it received in the notification in order to initiate the application session during step 4.5. During step 4.6, the application session between the client and the server is established. The server can then communicate with the client using this application session.

1. Method of establishing an application session by an information processing device called client, having means for communicating with a data communication network through a mobile telephony network, comprising the following steps:
a step of receiving a notification according to a first asynchronous communication mode;
a step of extracting from said notification, firstly information for establishing an application session and secondly connection information relating to the operator managing an interconnection gateway between the mobile telephony network and the data communication network;
and, in response to the reception of said notification, comprising the following steps:
a step of initiating a synchronous connection to said gateway using extracted connection information relating to the operator;
a step of initiating an application session by means of the information relating to the application session extracted.

2. Method according to claim 1, wherein said notification is received in the form of a short message.

3. Method according to claim 1, wherein the step of extracting from said notification, firstly the information for establishing an application session and secondly the connection information relating to the operator managing an interconnection gateway between the mobile telephony network and the data communication network, comprises a step of extracting the name of the gateway, a connection identifier and a password.

4. Information processing device comprising:
means for communicating with a data communication network through a mobile telephony network;
means for receiving a notification according to a first asynchronous communication mode;
means for establishing a connection according to a second synchronous communication mode with an interconnection gateway between the mobile telephone network and the data communication network, said gateway being managed by an operator;
means for establishing with a server an application session through the communication network;
wherein said information processing device also comprises:
means for extracting from said notification, firstly connection information relating to the operator used to enable establishment of a connection to the data communication network, and secondly information relating to the establishment of an application session,
wherein the means for establishing a connection with the gateway and the means for establishing an application session with the server are activated in response to the reception of said notification.

5. Notification format for the establishment of an application session by an information processing device called client having means for communicating with a data communication network through a mobile telephony network, comprising:
the information for establishing an application session; and
the connection information relating to the operator managing an interconnection gateway between the mobile telephony network and the data communication network.

6. Notification format according to claim 5, wherein it takes the form of a short message.

7. Notification format according to claim 5, wherein said connection information relating to the operator comprises the name of the gateway, a connection identifier and a password.
